(19) United States
(12) Patent Application Publication
(10) Pub. No.: US 2025/0034722 A1
(43) Pub. Date: Jan. 30, 2025

(54) METHOD FOR DISSOCIATING WATER MOLECULES TO OBTAIN HYDROGEN AND OXYGEN GAS AND APPARATUS FOR DISSOCIATING WATER MOLECULES

(71) Applicant: ADASUNE S.R.O., Hradec Kralove (CZ)

(72) Inventor: Viktor KORBEL, Stráž nad Nežárkou (CZ)

(21) Appl. No.: 18/716,527

(22) PCT Filed: Dec. 13, 2022
(86) PCT No.: PCT/CZ2022/050130

§ 371 Date: Jun. 5, 2024

(30) Foreign Application Priority Data
Dec. 14, 2021 (CZ) 2021-568

(51) Int. Cl. C25B 1/04; C25B 9/65; C25B 11/02

(52) U.S. Cl. CPC C25B 1/04; C25B 9/65; C25B 11/02

(57) ABSTRACT

The invention relates to a method of producing hydrogen and oxygen gas by dissociating water molecules which are decomposed by an electric field, the intensity of which is increased unevenly in a periodic repetition until the electric field imparts sufficient excitation energy to the water molecule. The dissociation products are stabilized by photons and diverted for further use.

### AREA OF TECHNOLOGY

The invention relates to a method of producing hydrogen and oxygen gas by dissociating water molecules for subsequent use in the energy industry, and further relates to a device for carrying out the dissociation of water molecules.

### STATE OF THE ART

Ways are currently being sought to address the energy crisis caused by the exclusion of fossil fuels from the energy industry. One of the possible substitutes for fossil fuels is hydrogen gas, which appears to be a suitable candidate for replacing the burning of fossil fuels.

Hydrogen gas has the advantage of being widespread in the environment, in the form of water. Each molecule of water contains two hydrogen atoms and one oxygen atom. When hydrogen burns, a large amount of energy is released and the product of combustion with oxygen is water vapour. This is a big advantage over fossil fuels, which release greenhouse gases, toxins and dust when they burn.

The disadvantage of these pure gases is their high reactivity, which is very dangerous in case of improper handling, accident or malfunction. It is therefore desirable that the pure gases should not be stored in large volumes in tanks, but that there should be a facility and method for their continuous production before immediate consumption. This would be advantageous, since clean water would be stored in tanks as a feedstock, the eventual leakage of which from the storage tank is a minor safety risk.

Another disadvantage of using pure hydrogen and oxygen as a replacement for fossil fuels is the complexity of production, as breaking down a water molecule into atoms is a relatively complex process.

An example of the well-known production of hydrogen from water molecules is electrolysis, in which water is mixed with an electrolyte and then a direct electric current is passed through it. At one of the electrodes, the electric current causes oxygen to be emitted from the electrolyte in addition to other atoms, and at the other electrode, hydrogen is emitted from the electrolyte in addition to other atoms. Adversely, during electrolysis, the other atoms bind to other atoms present, in particular to atoms of the electrode material, and coatings are formed which may act as an insulating material making further electrolysis difficult. Furthermore, it is disadvantageous to work with DC electric current, which is very life-threatening even at low voltage levels. Last but not least, it is disadvantageous that electrolyte and electrodes have to be used, which complicates the consideration of simply using water, as the only feedstock, in the hydrogen and oxygen production process.

It is an object of the invention to provide a method of producing hydrogen and oxygen from water molecules that is energy efficient, that allows water to be processed into gaseous components just before consumption, that does not require additional feedstock, and it is further an object of the invention to provide a device for carrying out the inventive method.

### THE ESSENCE OF THE INVENTION

The present problem is solved by a method of dissociating water molecules to obtain hydrogen and oxygen gas according to the invention below.

The essence of the invented method lies in the sequential steps:
(a) water is poured between the electrodes to form an electrical capacitor in which water represents the dielectric.
(b) A nonlinearly increasing electric field is generated between the electrodes by placing a capacitor in a series-connected tuned LC circuit until some water molecules decay into hydrogen gas and oxygen gas, while the gas ions are stabilized by photon irradiation. By incorporating a capacitor into a series tuned LC circuit, it is possible to generate an electric field between the electrodes, the strength of which, due to high frequency charging and discharging, gradually but non-linearly increases, thereby stressing the water molecules, whereby some of the molecules receive excitation energy by the force of the electric field, causing them to decay into electrically charged atoms of gaseous elements. To prevent the ions from reacting immediately, the missing charge is supplied by interaction with photons.
(c) the gaseous elements shall be discharged outside the condenser space. The gaseous elements are actively removed so that the concentration of the gaseous elements does not increase so much that they combine again.

In the method, steps (b) and (c) are repeated, but in step (b), the parameters of the non-uniformly increasing electric field are adjusted according to the current electrical capacitance of the capacitor determined by the amount of water present between the electrodes. The amount of water changes as the molecules decompose, thus changing the parameters of the capacitor, which affects the parameters of the generated electric field.

The frequency of charging and discharging the electrical charge in the capacitor preferably ranges from 50 kHz to 1 MHz. At the same time, it is advantageous if the frequency increases with increasing electrical conductivity of the water. While distilled water is a poor conductor of electric current and can substitute for the dielectric of the capacitor already at lower frequencies, e.g. seawater with salt ions is a good conductor of electric current and therefore a much higher frequency of charging and discharging of the electric charge in the capacitor must be used in order to arrange the molecules and ions leading to an increase in the electrical resistance in the dielectric region, the so-called capacitance, which causes a decrease in the electrical conductivity.

It is advantageous if the photons for stabilization come from UV light.

The invention also includes a device for dissociating water molecules to obtain hydrogen gas and oxygen gas in the inventive manner.

The essence of the invention is that the device comprises a reactor and a high frequency electrical voltage source. The reactor is used for the dissociation process of the water molecules, while the high frequency voltage source is used to initiate the generation of an electric field acting on the water molecules.

The reactor includes a hermetically sealed vessel of electrically inert material. The hermetically sealed vessel prevents the sudden ignition of hydrogen with air, while protecting against electric shock. The reactor further comprises at least two tubular electrodes which are concentrically arranged and have gaps between them. The concentric arrangement of the electrodes substantially replicates the established design of capacitors, wherein the electrodes are wound in layers on top of each other, the layers being interleaved with a dielectric. In the case of a reactor, the dielectric becomes water, which fills the gaps between the electrodes. The electrodes are in a hermetically sealed reactor vessel. Another part of the reactor is at least one light source to irradiate the space inside the reactor with photons that stabilize ions from the decayed molecules. At the same time, the reactor is provided with at least one gas element vent. A high frequency power source shall be electrically connected in series to the electrodes of the reactor to form an LC circuit.

The design of the device is simple but effective. The concentric electrodes create enough gaps for the water to flood, and their arrangement allows them to apply a coherent electric field to the water. The reactor is safe and can be sized as required.

In a preferred embodiment of the invention, the high frequency power source is a power source with a read-back of the operating frequency. Due to the read-back of the operating frequency, the parameter setting in the LC circuit occurs spontaneously, so that the capacitor capacitance does not have to be actively measured and the source subsequently actively readjusted. This is important because the course of dissociation of the water molecules in the reactor is essentially unique each time and continuously changing over time, and it is therefore important that the high frequency source itself responds automatically at high speed to the change in capacitor capacitance.

Preferably, the reactor is provided with at least one water supply for continuous water refilling and uninterrupted operation.

It is also advantageous if the light source comprises a light emitting diode, preferably a UV light emitting diode. Light emitting diodes produce less waste heat than conventional filament light sources. In addition, they are suitable for miniaturisation, and are durable. UV light-emitting diodes produce light at a wavelength that is shown in current experiments to be the most optimal for stabilizing ions from decomposed water molecules.

Among the advantages of the invention is that electrical decomposition of water molecules occurs without the need for the input of additional raw materials. The decomposition of water molecules by means of an electric field is resistant to electromagnetic fields that could cause interference, and at the same time there are no discharges within the invention, so there is no risk of free gas ignition. The inventive device is simple in design, but its operation is maximally efficient.

### CLARIFICATION OF DRAWINGS

The said invention will be explained in more detail in the following illustrations, where:

FIG. 1 in a simplified graphic shows the periodic repetitive increase of the electrical voltage applied to the electrodes of the capacitor,

FIG. 2 shows a simplified reactor model of the plant,

FIG. 3 shows the bottom view of the reactor model in FIG. 2.

### EXAMPLE OF THE EMBODIMENTS OF AN INVENTION

It is understood that the specific embodiments of the invention described and illustrated below are presented for purposes of illustration and not as a limitation of the invention to the examples provided. Those skilled in the art will find or be able to provide, using routine experimentation, a greater or lesser number of equivalents to the specific embodiments of the invention described herein.

The dissociation of water molecules is achieved by repeatedly exposing the water molecules to an extreme electric field with a changing tendency, which can provide the atoms of the molecule with the necessary excitation energy to overcome their mutual bonding.

The electric field must increase nonlinearly in its value in order for the molecules to be energetically stressed by the increase and decrease of the field. In macroscopic layman's terms, to get a better idea of the effect, the water molecules must be vibrated with increasing intensity until the hydrogen atoms bounce off the oxygen atom.

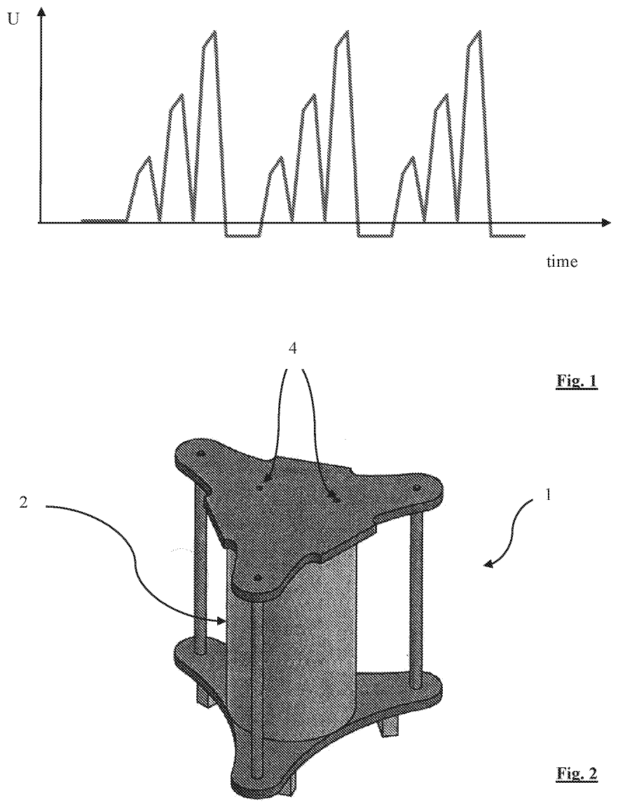

The electric field is generated between the electrodes of a capacitor whose dielectric is water. The non-linear increase in the electric voltage, which directly proportional affects the electric charge on the electrodes of the capacitor, is shown in FIG. 1.

This process is repeated continuously as long as water is present between the electrodes of the condenser and as long as there is a need to produce gaseous elements.

The frequency of the rise and fall of the electrical voltage is modified in FIG. 1 to make the method easier to understand, but in reality the operating frequency ranges from 50 kHz to 1 MHz, which means up to 1 000 000 repetitions of the phenomenon in one second. This extreme stress on the bonds in water molecules causes them to break down. In addition, it has been verified that the conductivity of the water between the electrodes decreases with increasing frequency. This is important because it is possible to process any water, not just distilled water. Due to the higher frequencies, the electrical charge is concentrated at the electrodes of the capacitor and an inactive region is formed in the gap between the plates in terms of electrical conductivity. Practical experiments with a laboratory reactor showed that frequencies of up to 280 kHz were sufficient for distilled water, frequencies from 720 kHz to 1 MHz were usable for salted water with 5% salinity table salt, while frequencies from 430 kHz to 650 kHz worked for tap water.

As for the amplitudes of the working electrical voltage, this depends on several factors. Firstly, it depends on the properties of the water to be treated, then on the surface area of the capacitor electrodes and the distance of the capacitor electrode surfaces from each other, then on the amount and temperature of the water, then on the degree of dissociation of the water molecules, etc.

For this reason, the capacitor is connected to a tuned LC circuit which, through tuning, responds to the immediate demand of the system to generate the desired extreme electric field. The advantage of the LC circuit is that when it goes into resonance, it can discharge and charge the electrical charge in the electrodes with the desired frequency, and the magnitude of the electrical charge can be increased according to the tendency depicted in FIG. 1. The power source of the LC circuit is so-called feedback, which means that it responds to changes by itself. A feedback coil is used in the source, which when charged, closes the source tube, causing an oscillation-frequency. The use of a controlled source cannot be ruled out, but such a solution appears at first sight to be unnecessarily complex.

The water can be gradually depleted and the source reacts automatically, or it can be continuously replenished, which the source again handles on the basis of the above principle.

Since the dissociation of water molecules releases an electrical charge in the form of electrons that are drawn to one of the electrodes of the capacitor, it is necessary to stabilize the gaseous element ions to prevent recombination into other new water molecules. The electric charge is supplied to the ions by irradiation with photons, ideally UV light, whose photons have sufficient energy to stabilize them, and all that has to happen is that the gas ion is struck by the UV photon. It is also possible to use photons of light from the visible spectrum, or energetic particles from sources other than light.

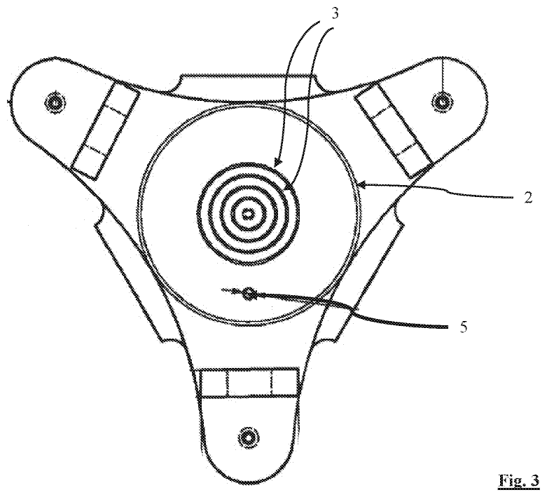

FIG. 2 shows reactor 1 of the plant for hydrogen production by dissociation of water molecules. The reactor 1 exhibits a hermetically sealable container 2 made of Plexiglas, which is cylindrical in shape and closed by two flanges. Inside the hermetically sealed vessel 2 there are electrodes 3 of tubular shape, which are concentrically arranged and spaced apart for flooding with water. There are five tubular electrodes 3 in total, as shown in FIG. 3.

FIGS. 2 and 3 also show openings 4 for the gas outlet, and opening 5 for the continuous water supply.

The high-frequency voltage source is principally built from a Tesla transformer, which works on the resonant principle. An important part of the power supply is an electronic high-frequency oscillator, from which the high-frequency voltage is applied to the electrodes of the capacitor, whereas in a conventional Tesla transformer the voltage is applied to a coil to generate secondary discharges, e.g. for testing the insulation strength of materials. The damped spark oscillator is adapted for readback to respond to changes in the capacitance of the reactor capacitor 1 and remain in resonance.

### INDUSTRIAL APPLICABILITY

The method and apparatus for dissociating water molecules to obtain hydrogen and oxygen gas according to the invention will find application in the energy industry.

1. A method of dissociating water molecules to obtain hydrogen and oxygen gas, comprising the following process steps: (a) water is poured between the electrodes to form an electrical capacitor in which the water represents the dielectric, (b) a nonlinearly increasing electric field is generated between the electrodes by including the capacitor in a series-wired tuned LC circuit until some of the water molecules dissociate into hydrogen gas and oxygen gas, and the gas ions are stabilized by photon irradiation, (c) the gaseous elements are vented out of the capacitor space, whereupon steps (b) and (c) are repeated, whereby in step (b) the parameters of the non-uniformly increasing electric field are adjusted according to the actual electrical capacitance of the capacitor as determined by the amount of water present between the electrodes, while at the same time the frequency of charging of the electrical charge in the capacitor is varied from 50 kHz to 1 MHz.

2. The method according to claim 1, wherein the stabilization of the ions by irradiation with photons is carried out using a light source.

3. The method according to claim 2, wherein UV radiation is used.

4. A method according to claim 1, wherein the frequency of charging of the electrical charge in the capacitor increases with increasing electrical conductivity of the water.

5. An apparatus for dissociating water molecules to obtain hydrogen and oxygen gas in the manner according to claim 1, wherein it comprises a reactor (1) and a high frequency electrical power source, wherein the reactor (1) comprises a hermetically sealed vessel (2) of electrically inert material, at least two electrodes (3) of tubular shape, which are concentrically arranged in relation to each other and which are inserted into the hermetically sealed container (2) of the reactor (1), at least one light source for irradiating the space inside the reactor (1) with photons, the reactor (1) being provided with at least one opening (4) for venting gaseous elements, and at the same time a high frequency electrical voltage source is electrically connected in series to the electrodes (3) of the reactor (1).

6. The apparatus according to claim 5, wherein a high frequency power supply is a power supply with a read-back of the operating frequency.

7. The apparatus according to claim 5, wherein the reactor (1) is provided with at least one opening (5) for water supply.

8. A device according to claim 5, wherein the light source comprises light emitting diodes.

9. The device according to claim 8, wherein the light source comprises a UV light emitting diode.
